(19) United States
(12) Patent Application Publication
(10) Pub. No.: US 2009/0292376 A1
(43) Pub. Date: Nov. 26, 2009

(54) PLAYLIST EXECUTION IN A SCHEDULED PROGRAMMING ENVIRONMENT

(75) Inventors: Firas Kazem, Ottawa (CA); Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: Nortel Networks Limited, St. Laurent (CA)

(21) Appl. No.: 12/167,460

(22) Filed: Jul. 3, 2008

Related U.S. Application Data
(60) Provisional application No. 61/055,841, filed on May 23, 2008.

(51) Int. Cl. G06F 17/00

(52) U.S. Cl. 700/94

(57) ABSTRACT

The present invention relates to generating and executing a playlist in a scheduled programming environment. In one embodiment, a media content recommendation for select media content is received from a first entity. The select media content for the media content recommendation is then added to a playlist for a first user. The playlist will identify numerous media content items to be consumed at particular times, in a particular order, or a combination thereof. The playlist is provided to a content control function, which controls, either directly or remotely, a scheduled programming interface (SPI) device to execute the playlist. The SPI device effectively consumes the media content items of the playlist in an automated fashion. Consumption of the media content items may include presenting the media content to the first user via an audio or video monitor, recording the media content in local or remote storage, or a combination thereof.

This application claims the benefit of U.S. provisional patent application Ser. No. 61/055,841 filed May 23, 2008, the disclosure of which is incorporated herein by reference in its entirety.

### FIELD OF THE INVENTION

The present invention relates to scheduled programming, and in particular to executing playlists in a scheduled programming environment.

### BACKGROUND OF THE INVENTION

The number of television channels available to a viewer through cable or satellite services is continuously growing. It is not uncommon to have more than one hundred channels of scheduled programming content available at any time. Further, many users have access to numerous programs at any given time through video on demand (VoD) services and programs that have been previously recorded on their digital video recorder (DVR) or a network-based personal video recorder (PVR), which is located in a service provider's network. Given the ever-increasing number of available channels and accessible programs, users are having a difficult time identifying what is available and selecting what to watch or record. In many instances, flipping through channels or consulting program guides is inefficient and ineffective. To further complicate matters, Internet Protocol television (IPTV) services, video sharing sites, Internet broadcasters, and the like have proliferated, and the amount of media content available overwhelms most users and makes it virtually impossible to effectively search and select media content to view or record.

Many audio and video sharing services that reside on the Internet take advantage of being able to receive recommendations from other users. These recommendations are an efficient way to allow users to share their favorite content with other users who have similar interests. As such, these recommendations often provide an effective tool for identifying desired media content. Further, these audio and video sharing websites allow users to generate playlists of their favorite media content, wherein the playlists are downloaded to personal computers or media players to control playback of the selected media content. Unfortunately, such a process is not available for television-based services. Most television services are provided by broadcast, satellite, or cable service providers and are controlled by scheduled programming interface (SPI) devices, such as set-top boxes, digital video recorders (DVRs), cable cards, and the like, which are heavily reliant on basic programming guides. These programming guides have limited search capabilities and provide no way of automating a viewing schedule. At best, the programming guides allow a user to mentally make note of a desired programming schedule or program a DVR to record select programs. Accordingly, there is a need for a more efficient technique to select media content for viewing or recording at an SPI device. There is a further need for a technique to automate the viewing or recording experience provided by an SPI device.

### SUMMARY OF THE INVENTION

The present invention relates to generating and executing a playlist in a scheduled programming environment. In one embodiment, a media content recommendation for select media content is received from a first entity. The select media content for the media content recommendation is then added to a playlist for a first user. The playlist will identify numerous media content items to be consumed at particular times, in a particular order, or a combination thereof. The playlist is provided to a content control function, which controls, either directly or remotely, a scheduled programming interface (SPI) device to execute the playlist. As such, the SPI device effectively consumes the media content items of the playlist in an automated fashion. Consumption of the media content items may include presenting the media content to the first user via an audio or video monitor, recording the media content in local or remote storage, or a combination thereof.

The SPI device may be configured to operate in a standard mode or a playlist mode. In the standard mode, the SPI device will generally operate as a standard set-top box, digital video recorder (DVR), or the like. In the playlist mode, the SPI device will facilitate execution of the playlist in a substantially automated fashion. In addition to identifying media content corresponding to various audio or video programs, the playlist may be supplemented with advertising content. Accordingly, advertising content may be consumed along with the media content in a manner defined by the playlist. The advertising content may be targeted and provided during selected slots within particular media content items, between consumption of media content items, and the like. The advertising content may be targeted to the particular user associated with the playlist based on the media content identified in the playlist, information associated with the user, or a combination thereof.

In a preferred embodiment, the media content of the playlist is television content, which is available to the user through scheduled programming, video on demand services, local or remote storage devices, or any combination thereof. For scheduled program media content, the scheduled programming interface device will select the channel for the media content at an appropriate time and effect playback or recording of the media content. For locally stored media content, the scheduled programming interface device will effect playback of the media content at an appropriate time or in an appropriate order. For remotely stored media content, the scheduled programming interface device will request delivery of the media content and then effect playback or recording of the media content at an appropriate time or in an appropriate order.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is an illustration of a communication environment according to one embodiment of the present invention.

FIG. 2 is a flow diagram illustrating an exemplary recommendation process from the perspective of an application server according to one embodiment of the present invention.

FIG. 3 illustrates a playlist for a first user according to one embodiment of the present invention.

FIG. 4 illustrates an alternative implementation of the playlist of FIG. 3 according to another embodiment of the present invention.

FIGS. 5A and 5B are a flow diagram illustrating exemplary operation of an application server residing in a social networking environment according to one embodiment of the present invention.

FIG. 6 is a flow diagram illustrating an exemplary process for supplementing a playlist with advertising content according to one embodiment of the present invention.

FIG. 7 is a flow diagram illustrating operation of a scheduled programming interface device according to one embodiment of the present invention.

FIG. 8 is a block representation of an application server according to one embodiment of the present invention.

FIG. 9 is a block representation of a network control server according to one embodiment of the present invention.

FIG. 10 is a block representation of a scheduled programming interface device according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

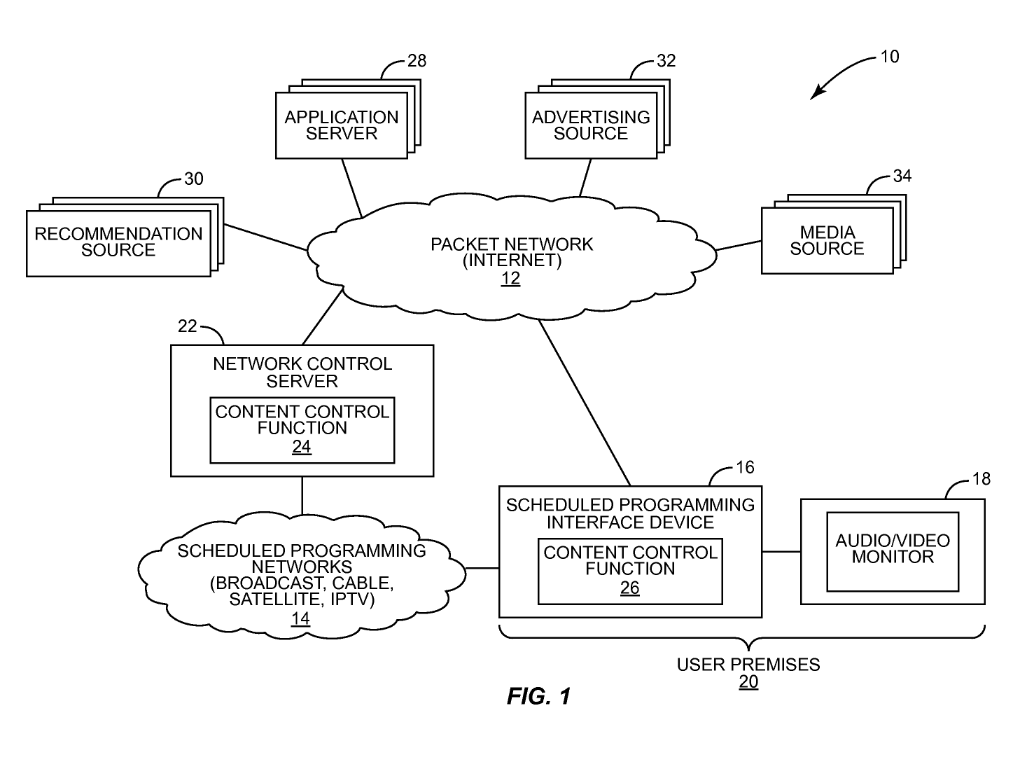

Prior to delving into the details of the present invention, an overview of a communication environment 10 in which certain embodiments of the present invention may be practiced is illustrated in FIG. 1. The communication environment 10 includes a packet network 12, such as the Internet, and one or more scheduled programming networks 14. The scheduled programming networks 14 may include traditional broadcast, cable, and satellite networks, as well as forthcoming Internet Protocol television (IPTV) networks, which may include the packet network 12. The essence of the scheduled programming networks 14 is that they provide scheduled programming services across numerous channels on a relatively continuous basis. In addition to providing scheduled programming, additional services such as video on demand and pay-per-view services may be provided. Accordingly, a subscriber to services provided by the service providers of the scheduled programming networks 14 will generally have access to numerous channels of programming content at any given time, wherein certain of the programming content is scheduled at defined times.

Typically, a scheduled programming interface (SPI) device 16 is located in or associated with an audio/video monitor 18 at user premises 20. The SPI device 16 may take the form of a set-top box, cable (or receiver) card, digital video recorder (DVR), personal video recorder (PVR), or the like, which is configured to recover the transmitted programming content for selected channels, and either record the recovered content or present the recovered content to the audio or video monitor 18 in traditional fashion. As those skilled in the art will recognize, the SPI device 16 is a generic representation of any device that has the basic functionality of a traditional set-top box or the like, which would include a satellite or cable box with or without recording capabilities.

The SPI device 16 is an intelligent device and is typically configured to interact with various entities in the scheduled programming networks 14 to control the delivery of programming content as well as receive instructions that will impact the delivery or selection of programming content. A network control server 22 may be associated with the scheduled programming networks 14 or the packet network 12 and, in certain embodiments, may be able to remotely control operation of the SPI device 16. For remote control, the network control server 22 may have a content control function 24 specifically configured to provide operational instructions to the SPI device 16. In other embodiments, the SPI device 16 will have a content control function 26, which is capable of locally controlling overall operation of the SPI device 16. According to one embodiment of the present invention, the content control function 24 of the network control server 22 or the content control function 26 of the SPI device 16 is adapted to obtain a playlist for a user associated with the SPI device 16 and control the SPI device 16 to execute the playlist. The playlist and execution of the playlist are described further below.

With continued reference to FIG. 1, the packet network 12, as well as the scheduled programming networks 14, may be associated with application servers 28, recommendation sources 30, advertising sources 32, and media sources 34. The application servers 28 may support various applications, such as social network applications like MySpace or Facebook. However, the concepts of the present invention are not limited to social networking applications. The recommendation sources 30 may represent various networks, servers, or entities from which recommendations for media content may be provided. Media content recommendations may be provided through different mechanisms, such as email, short message service (SMS) messages, instant messages (IMs), and the like, and may be based on a single user or a group of users.

The advertising and media sources 32, 34 may represent various servers or databases at which advertising content and media content, respectively, may be stored and subsequently retrieved. The advertising sources 32 may include various advertising servers, which not only store advertising content, but may provide targeted advertising services, which are used to select specific advertising content for delivery to a particular user based on various criteria. The media sources 34 may take various forms, including media content servers, network PVRs, and video on demand (VoD) servers. Although not limited thereto, the media sources 34 generally store media content that is made available upon request.

In one embodiment, an application server 28 is used to create a playlist for a particular user. The playlist identifies media content to be consumed by the user, wherein consumption by a user generally entails presenting the media content to the user or having the media content recorded for the user in a particular order or according to a desired schedule. The media content in the playlist may include scheduled programming content provided to the scheduled programming networks 14, locally stored media content that is stored in the SPI device 16 or associated equipment, remotely stored media content that is stored in one or more of the media sources 34, or any combination thereof. In other embodiments, the playlist may also identify advertising content to provide while executing the playlist. In certain embodiments, the user will control the media content provided in the playlist while a service provider or other entity may analyze the media content in the user's playlist and identify advertising content to provide in the playlist along with the media content that was selected by the user.

The user may access the applications server 28 to configure the playlist through the SPI device 16, a personal computer, a personal digital assistant, or the like, via various types of interfaces, including a web interface. The application server 28 may provide the user access to any number of guides or listing services, which identify the media content that is available to the user via the scheduled programming networks 14 and the media sources 34. Preferably, the application server 28 is configured to provide effective and efficient browsing and search tools, which will assist the user in identifying and selecting desired content for the playlist. In addition to searching through the available media content, the user is also provided recommendations from other users, entities, or services. Again, these recommendations are generally provided by one or more recommendation sources 30. The recommendations may be provided to the application server 28, which may process the recommendations and present them to the user for consideration when configuring their playlist. In other embodiments, the application server 28 may also be configured to control the SPI device 16 in the same way that the network control server 22 can control the SPI device 16.

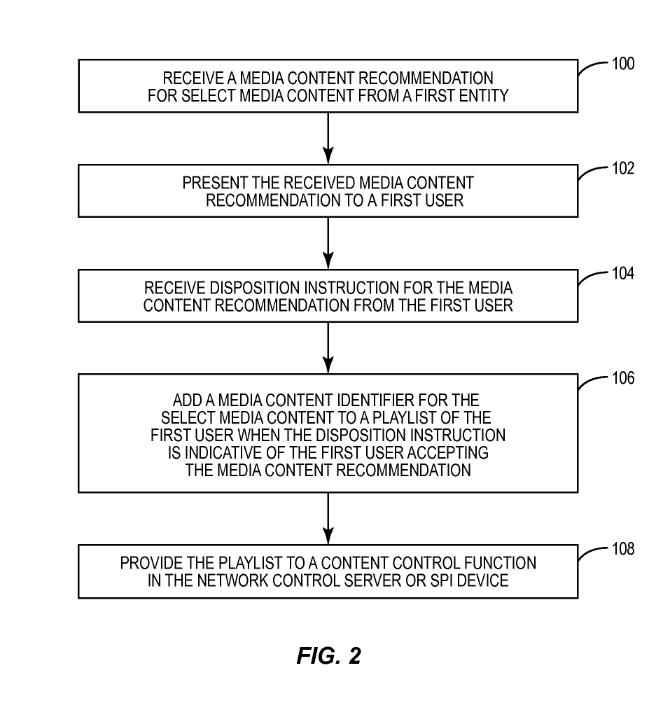

With reference to FIG. 2, an exemplary recommendation process is illustrated from the perspective of the application server 28, according to one embodiment of the present invention. Initially, the application server 28 will receive a media content recommendation for select media content from a first entity, such as one of the recommendation sources 30 (step 100). The application server 28 will present the received media content recommendation to a first user, who will consider the media content recommendation when configuring their playlist (step 102). The application server 28 will then receive a disposition instruction for the media content recommendation from the first user (step 104). The disposition instruction will inform the application server 28 as to whether the first user has accepted the media content recommendation and, if the media content recommendation has been selected, how the media content recommendation should be applied to the playlist.

Assuming the media content recommendation is accepted, the application server 28 will add a media content identifier for the select media content of the media content recommendation to the playlist of the first user (step 106). As such, the media content associated with the media content recommendation is added to the first user's playlist in response to instructions to do so by the first user. Once the playlist is complete, the application server 28 may provide the playlist to one of the content control functions 24, 26 of the network control server 22 or the SPI device 16, respectively (step 108). Once the content control function 24, 26 has access to the playlist of the first user, the first user may instruct the SPI device 16 to enter a playlist mode, which will trigger execution of the playlist on the SPI device 16. Execution of the playlist will cause the SPI device 16 to automatically effect playback or recording of media content that is identified in the playlist. Playback and recording of media content or the control thereof by the SPI device 16 is referred to as consumption of media content. The playlist will directly or indirectly include media content consumption instructions that will control how the media content in the playlist is consumed. Notably, additional instructions to control the recording of particular media content items may be provided in association with the playlist. Such recording instructions are considered separate from the consumption instructions for the playlist

In general, the media content identified in the playlist may be consumed in a particular order, at specified times, or a combination thereof. Those skilled in the art will recognize other ways in which the media content may be consumed; however, the most likely manner of consumption will be based on order, time, or a combination thereof. In one embodiment, the playlist will include scheduled program media content, which is provided via one of the scheduled programming networks 14 at one or more particular times on one or more particular channels. As such, the scheduled program media content may be associated with a particular channel and time. In such instances, the playlist may be based on a time schedule, wherein media content of the playlist is allocated to various time slots. Scheduled program media content is scheduled for a time slot in which the scheduled program media content is scheduled to be provided. Locally or remotely stored media content may be provided in other time slots, which are not taken up by scheduled program media content. Notably, not all time slots need to be filled, and various actions may be taken during time slots that are not allocated to particular media content and playlists. For example, the content control function 24, 26 may instruct the SPI device 16 to stay on a prior channel, select media content from a network or third party recommendation, allow the first user to manually control channel selection in a traditional fashion, or fill the open time slot with select advertising content. Tremendous flexibility is afforded to the first user as well as the service provider in addressing open time slots in a playlist.

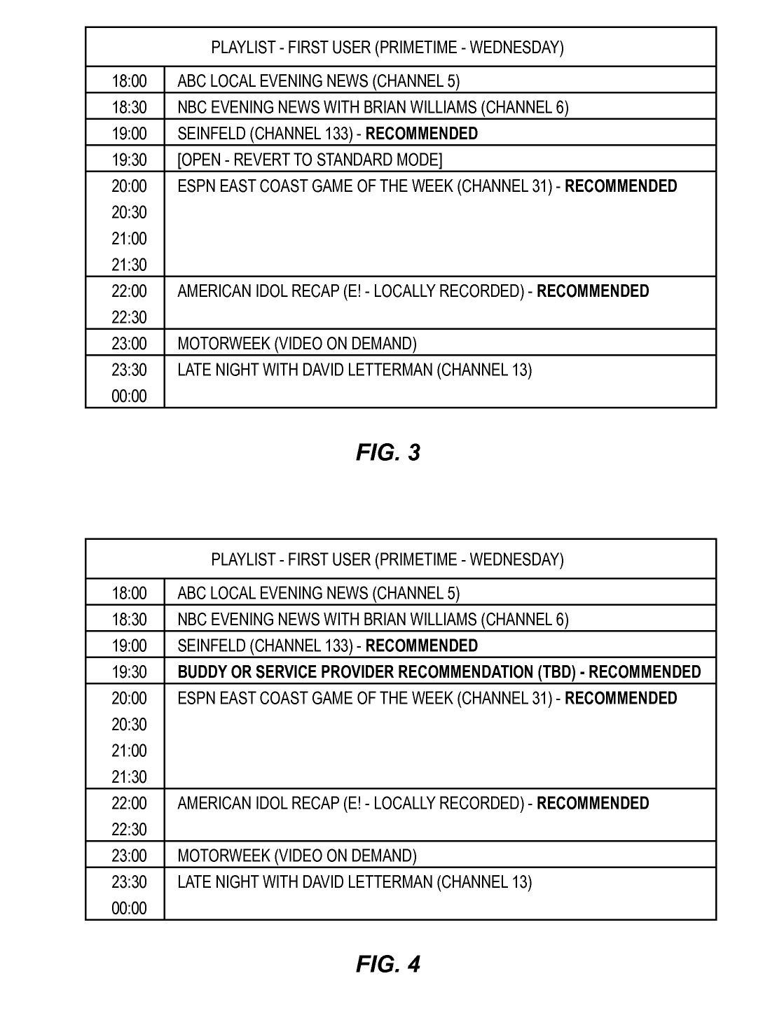

Exemplary playlists are provided in FIGS. 3 and 4. With particular reference to FIG. 3, a primetime playlist for Wednesday is provided for a first user. As illustrated, time slots from 18:00 (6:00 PM) to 00:00 (midnight) are mostly allocated to various types of media content. The playlist will cause the SPI device 16 to operate as follows. At 18:00, the SPI device 16 will select channel 5 for the ABC Local Evening News. At 18:30, the SPI device 16 will select channel 6 for the NBC Evening News with Brian Williams. At 19:00, the SPI device 16 will switch to channel 133 for Seinfeld. Notably, the time slot beginning at 19:30 is open, and the playlist includes instructions for the SPI device 16 to revert to a standard mode of operation, wherein the first user is free to select any channel desired. In essence, the SPI device 16 operates as a standard set-top box or PVR. At 20:00, the SPI device 16 will return to playlist mode and select channel 31 for the ESPN East Coast Game of the Week. At 22:00, the SPI device 16 will initiate playback of a locally recorded program, American Idol Recap, which was previously recorded from the Entertainment! Network (E!). At 23:00, the SPI device 16 will initiate a video on demand service to obtain Motorweek from a video on demand server, which is represented by one of the media sources 34. At 23:30, the SPI device 16 will return to the scheduled programming networks 14 and select channel 13 for Late Night with David Letterman.

As highlighted, the playlist includes three entries that were recommendations provided by one or more of the recommendation sources 30. These recommendations were provided to the application server 28, and selected by the first user for inclusion in the playlist. The recommendations were for Seinfeld, ESPN East Coast Game of the Week, and American Idol Recap. As those skilled in the art will recognize, media content recommendations may be provided for any type of media content, including the scheduled program media content, locally stored media content, and remotely stored media content. Further, when the playlist includes scheduled program media content, the corresponding time slots when the scheduled program media content is available will be defined. At other times, defined time slots may be filled with other scheduled program media content that is available at those scheduled times or locally or remotely stored media content. Further, the playlist may include a sequence of locally stored media content, wherein the media content is sequentially consumed without concern for time slots, unless and until scheduled program media content must be consumed according to the playlist.

For the playlist of FIG. 3, the 19:30 time slot was open and allowed the SPI device 16 to return to a standard mode, which allows the user to channel surf, engage video on demand services, or initiate playback of locally or remotely stored media content outside of the confines of the playlist. With reference to FIG. 4, an alternative implementation is provided wherein the 19:30 time slot is recognized as being open by the application server 28. In this embodiment, the application server 28 will take steps to automatically fill any open time slots based on general or specific preferences of the first user, service provider preferences, or any combination thereof. As such, the application server 28 may reconfigure to automatically provide a recommendation of a buddy of the first user or a recommendation of a service provider. Notably, the time slot may be filled at the time the playlist is completed or filled in a dynamic fashion at any time up to the open time slot. As such, the specific media content may not be available for viewing in the playlist and is to be determined (TBD) until a time deemed appropriate by the application server 28. Notably, the term “time slot” is used generically and includes defined start times.

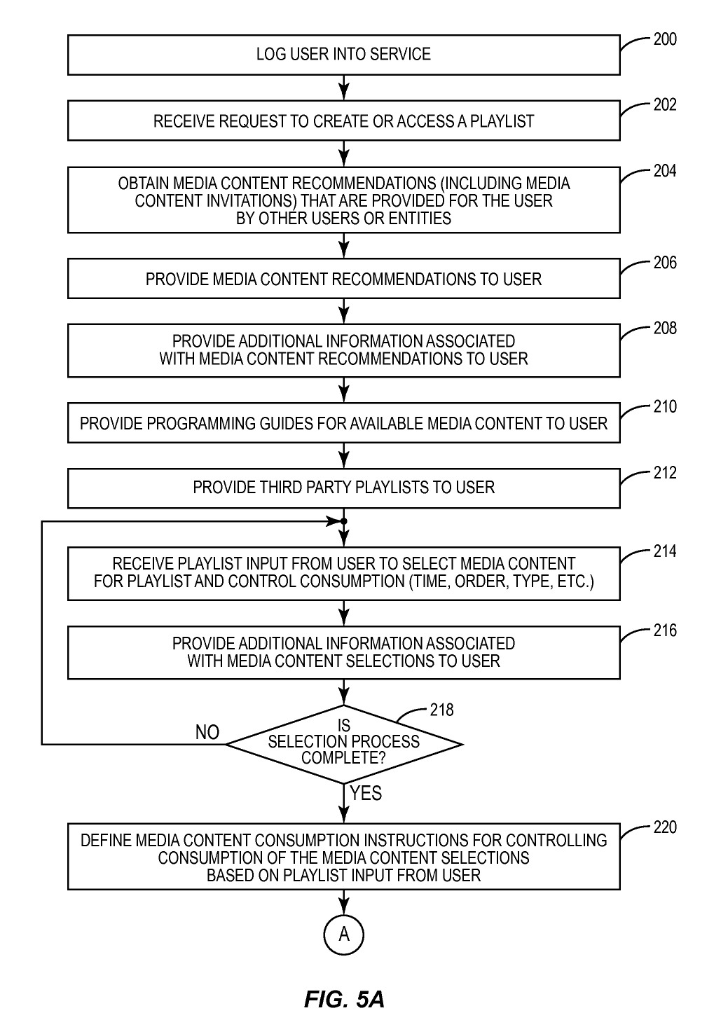

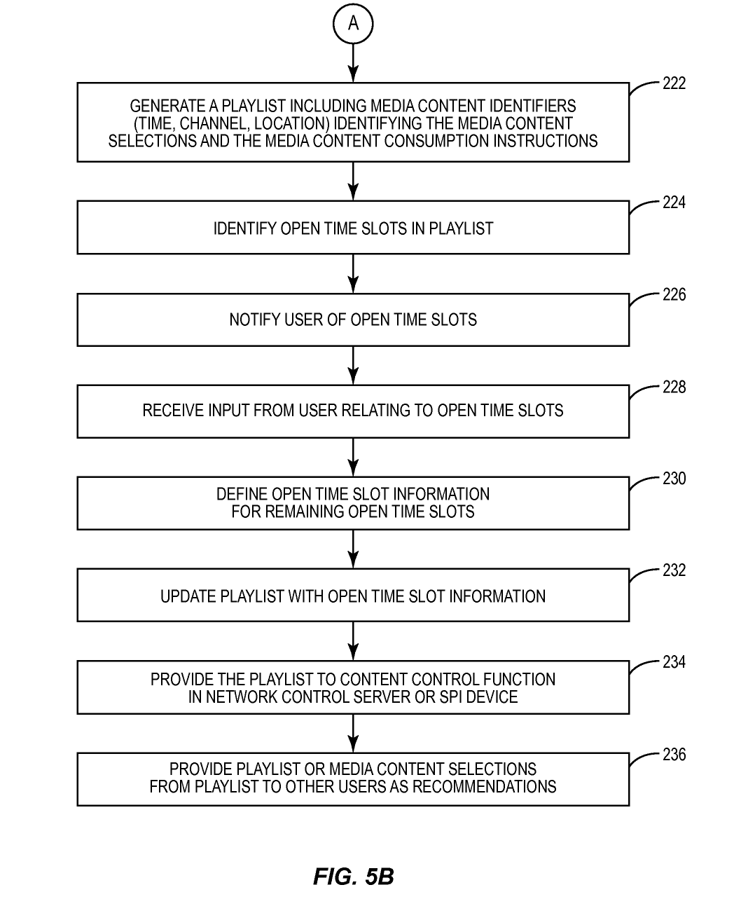

In one embodiment of the present invention, the application server 28 provides or is part of a social networking service where users are able to readily communicate with each other and share information among one another. With reference to FIGS. 5A and 5B, an exemplary operation of an application server 28 residing in a social networking environment is illustrated according to one embodiment of the present invention. Initially, the application server 28 will log a user into the social networking service and allow the user to participate in the normal social networking activities (step 200). At some point, the application server 28 will receive a request from the user to create or access a playlist, which is executable by the content control function 24, 26 of the network control server 22 or the SPI device 16 (step 202). In an ongoing fashion, the application server 28 is capable of obtaining media content recommendations, including media content invitations, that are provided for the user by other users, entities, or services, which again are represented by the recommendation sources 30 (step 204). These media content recommendations are provided to the user (step 206), who will take the media content recommendations into consideration when configuring their playlists. The application server 28 may also provide additional information associated with the media content recommendations to the user (step 208) as well as provide programming guides for any available media content, along with media content subject to the media content recommendations, to the user (step 210). The application server 28 may also identify playlists of other users and provide these playlists to the user for their review and analysis (step 212).

In light of all of the above information and any other information made available to the user through the application server 28 or through other sources, the user will provide playlist input that will control how the playlist is created or updated. As such, the application server 28 will receive playlist input from the user to select media content for the playlist as well as to control consumption of the media content according to the playlist (step 214). Again, the consumption of the media content may be controlled based on time, order, type of media content, and the like.

At this point, the media content for the playlist is available and the application server 28 may provide additional information that is associated with the media content selections to the user (step 216). This additional information may be general or specific information for the particular media content selections as well as further recommendations provided by the application server 28 based on the media content selections made by the user. This cycle may repeat until the process of selecting media content for the playlist is complete (step 218). Once this selection process is complete, the application server 28 may define media content consumption instructions that will be used for controlling the consumption of the media content selections based on the playlist input from the user (step 220). For example, the media content consumption instructions may identify an order in which the media selections should be consumed, time slots for consuming the media content, how the media content should be consumed (played or recorded), and the like.

At this point, a complete playlist may be generated, wherein the playlist will include media content identifiers that identify the media content selections along with the media content consumption instructions that will control how the media content selections will be consumed (step 222). The media content identifiers may identify the location of stored media content, the time and channel for scheduled programming content, and the like. In essence, the media content identifiers are sufficient to allow the SPI device 16 to select an appropriate channel at an appropriate time for scheduled program media content and access stored media content.

As discussed above, the application server 28 may identify open time slots in the playlist (step 224). If open time slots are identified, the application server 28 may notify the user of any open time slots (step 226). The application server 28 may receive input from the user relating to the open time slots (step 228) and define open time slot information for the remaining open time slots (step 230). Again, the open time slots may be handled in various ways based on the input from the user, previously stored user preferences, or preferences provided by a service provider. During the open time slots, the SPI device 16 may be instructed to revert back to a normal mode of operation until a time slot that has been scheduled is reached. If the playlist needs to be updated based on the open time slot information, the playlist is updated accordingly (step 232).

Next, the playlist is provided to the content control function 24, 26 of the network control server 22 or SPI device 16 (step 234). Upon arriving at the content control function 24, 26, the playlist may be executed to control operation of the SPI device 16. At this point, the application server 28 has a new playlist for the user. Based on the playlist or other criteria, the application server 28 may generate recommendations for other users based on the user's playlist and provide these recommendations to other users in the social networking environment (step 236).

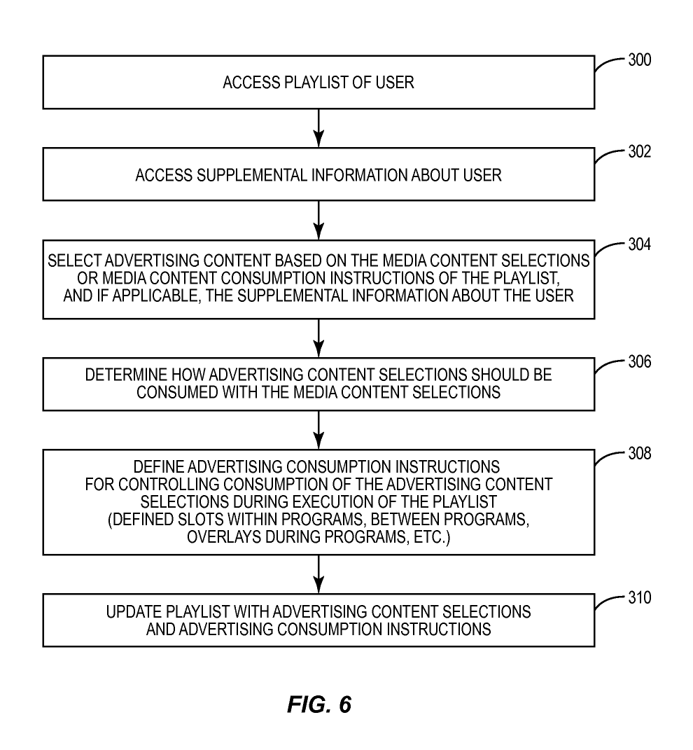

As indicated above, the playlist may be further supplemented with advertising media content. With reference to FIG. 6, an exemplary process is provided for supplementing the playlist with advertising content, which may be provided during or between the consumption of the various media content items in the playlist. Initially, the playlist of the user is accessed (step 300). In certain embodiments, supplemental information about the user may be accessed as well (step 302). This supplemental information may be virtually any type of information that can be used by the advertising sources 32 to assist in identifying targeted advertisements for the user. Accordingly, the application server 28 or the advertising sources 32 will select advertising content based on the media content selections or media content consumption instructions of the playlist and, if applicable, the supplement information about the user (step 304). The application server 28 or the advertising sources 32 will then determine how the advertising content selection should be consumed with the media content selections (step 306). Next, advertising consumption instructions are defined for controlled consumption of the advertising content selections during execution of the playlist (step 308). These advertising consumption instructions may dictate how and when to provide the selected advertising content. Again, the advertising content may be provided into defined slots within certain programs, between programs, as overlays during programs, and the like, wherein each program corresponds to a media content item. Finally, the playlist is updated with the advertising content selections and the advertising consumption instructions (step 310). The application server 28 will then cause the updated playlist to be delivered to the content control function 24, 26, which ultimately controls the SPI device 16.

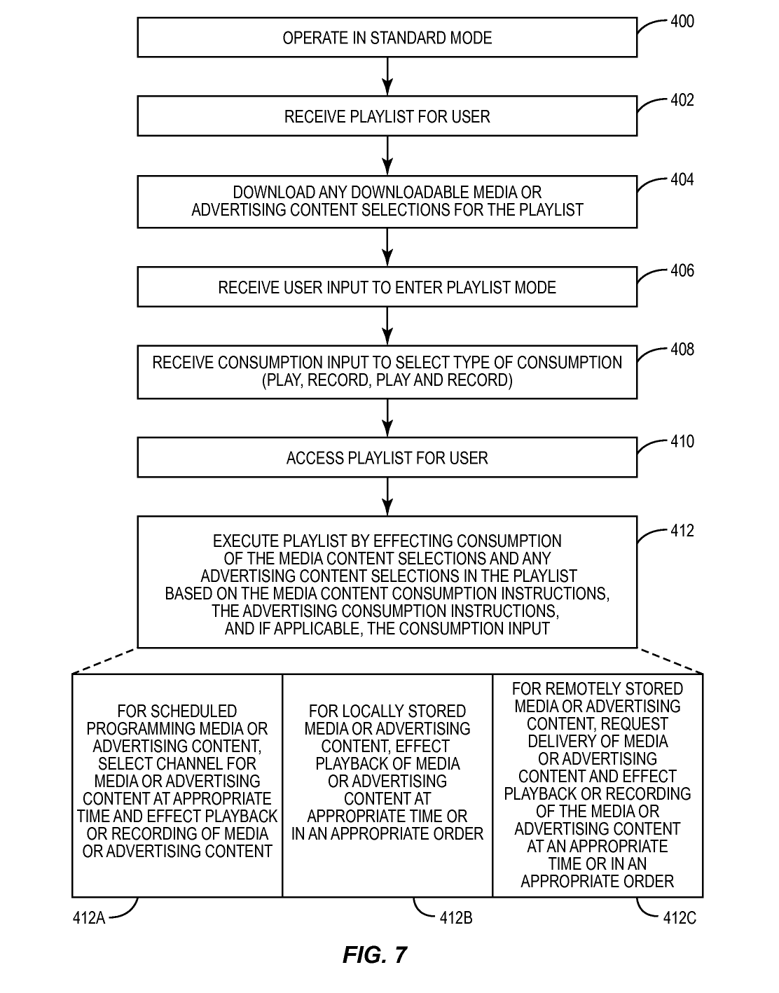

With references to FIG. 7, a flow diagram is provided to illustrate operation of the SPI device 16 according to one embodiment of the present invention. Operation of the SPI device 16 is based on the appropriate content control function 24, 26 and how the content control function 24, 26 executes the playlist. Initially, assume the SPI device 16 is operating in a standard mode, wherein the user is free to control the SPI device 16 in a traditional fashion (step 400). The content control function 24, 26 may receive the playlist for the user from the application server 28 (step 402) and initiate the downloading of any downloadable media or advertising content selections for the playlist to the SPI device 16, a device associated with the SPI device 16, or one of the media sources 34 (step 404). Notably, the downloadable media or advertising content selections may be downloaded to the SPI device 16 or an associated device from the media sources 34. In other embodiments, the media sources 34 may obtain all or certain of the downloadable media or advertising content selections from other databases or the like.

At some point after receiving the playlist, assume the user instructs the SPI device 16 to enter a playlist mode. Upon receiving the user input instructing the SPI device 16 to enter the playlist mode (step 406), the SPI device 16 will stop operating in the standard mode. Further, the SPI device 16 may receive consumption input to select a particular type of consumption to apply to the playlist, assuming the playlist does not specify the type of consumption or the consumption input overrides the type of consumption provided in the playlist (step 408). Next, the content control function 24, 26 will access the playlist for the user (step 410) and execute the playlist.

Execution of the playlist involves effecting consumption of the media content selections and any advertising content selections in the playlist based on the media content consumption instructions, the advertising consumption instructions and, if applicable, the consumption input (step 412). For scheduled programming media or advertising content, the SPI device 16 will select a channel for the media or advertising content at an appropriate time and effect playing or recording of the media or advertising content (step 412A). For locally stored media or advertising content, the SPI device 16 will effect playback of the media or advertising content at an appropriate time or in an appropriate order (step 412B). Notably, the locally stored media and advertising content may be downloaded in response to receiving the playlist and stored for use when the playlist is being executed. For remotely stored media or advertising content, the SPI device 16 will request delivery of the media or advertising content and effect playing or recording of the media or advertising content at an appropriate time or in an appropriate order (step 412C). In some cases, the media content selections, including the recommended media content, may be for channels that are not part of the normal channel subscription for the user. In those instances, the media content consumption instructions may include temporary information, such as unlocking codes, that will give access to the required channels for media consumption. Various pre- or post-consumption billing methods can be used by the media content providers for this type of a la carte consumption.

Although the application server 28 may allow the user to select and modify their own playlist based on various criteria as well as recommendations from the various recommendation sources 30, the application server 28 may also generate or obtain playlists from other users, entities, or services. These playlists may be provided to the content control function 24, 26 and used to control the SPI device 16 of the user as if the playlist were the user's playlist. For example, the application server 28 may create specialized playlists that it will distribute to the subscribers. These specialized playlists may include a list of the most viewed media content based on various criteria, including geographic location, the user's age or sex, and the like. Playlists may be created for different genres, interests, and the like. For example, the application server 28 may generate movie, comedy, sporting event, cooking, home improvement, or like playlists wherein corresponding media content is used to build a playlist that fills all or a portion of the user's available consumption schedule. Further, the user may join affinity groups that are composed of other users having common interests. The application server 28 may facilitate the exchange of communications among these users within the affinity groups. These users may become recommendation sources 30 or sources of playlists.

One embodiment of the present invention provides the ability to build a playlist based on scheduled program media content, such as television content, and use the playlist to control the SPI device 16 in an automated fashion. In many instances, a particular media content item may be available to a user at different times, on different channels, by different service providers, and the like. In such situations, the application server 28 is preferably configured to sort out the appropriate time, channel, and service provider and allow the user to readily add the media content item to the playlist. The same capabilities may be provided for advertising content. Notably, the playlists may be stored virtually anywhere, as long as they are available to the entities executing or effecting execution of the playlists. For example, the playlists may be maintained at the application server 28, network control server 22, SPI device 16, or other service node.

In other instances, media content items that start or are otherwise available at the same time and on different channels may be selected for the playlist. For SPI devices 16 with multiple tuners, both media content items may be delivered to the SPI device 16 at the same time. Based on appropriate media content consumption instructions, the SPI device 16 may be used to play one media content item and record the other, or record both media content items. Advertising content items may be handled in a similar fashion.

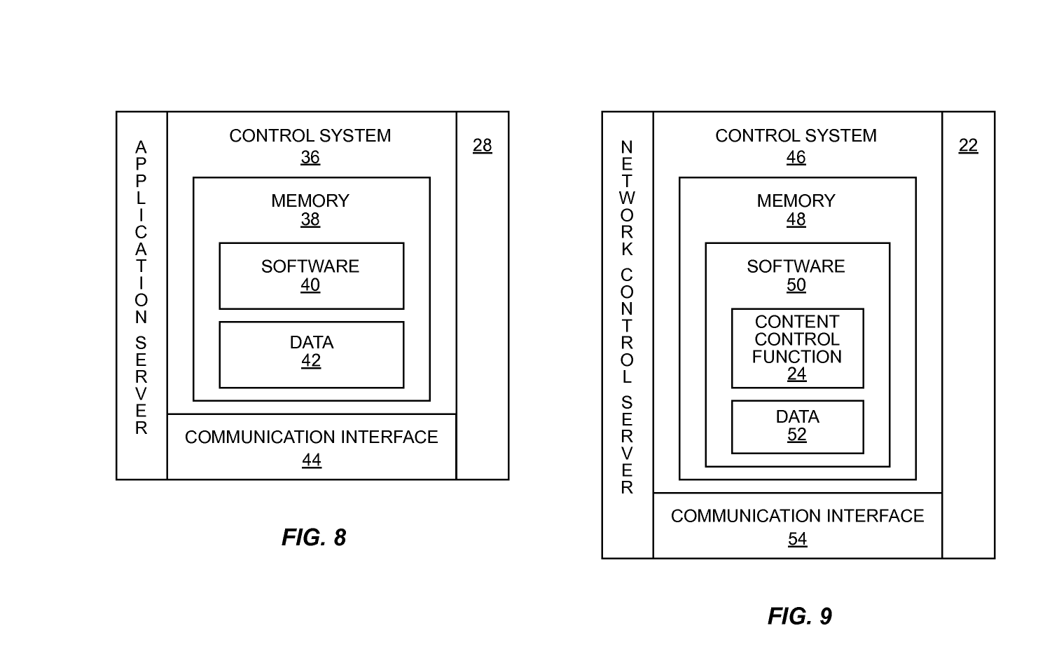

With reference to FIG. 8, a block representation of an application server 28 is illustrated according to one embodiment of the present invention. The application server 28 will include a control system 36 having sufficient memory 38 for the requisite software 40 and data 42 to operate as described above. The control system 36 will be associated with a communication interface 44 to facilitate communications with the various entities of the communication environment 10.

With reference to FIG. 9, a network control server 22 is illustrated according to one embodiment of the present invention. The network control server 22 will include a control system 46 having sufficient memory 48 for the requisite software 50 and data 52 to operate as described above. Notably, the software 50 may include the content control function 24. Further, the control system 46 may be associated with a communication interface 54 to communicate with the various entities in the communication environment 10.

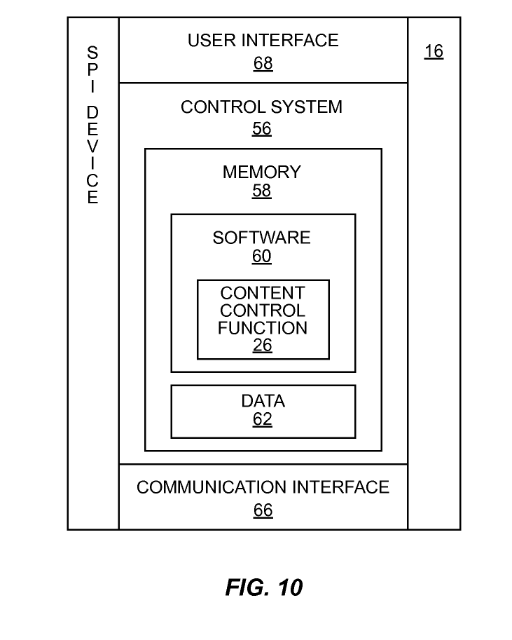

With reference to FIG. 10, an SPI device 16 is illustrated according to one embodiment of the present invention. The SPI device 16 will include a control system 56 having sufficient memory 58 for the requisite software 60 and data 62 to operate as described above. The software 60 may include a content control function 26. Further, the control system 56 may be associated with a communication interface 66 as well as a user interface 68. The communication interface 66 will facilitate communications with various entities in the communication environment 10. The user interface 68 will facilitate interactions with the user. Depending on the configuration, the SPI device 16 may have a different user interface or may use the communication interface 66 to connect to an applicable audio or video monitor 18. Further, the functionality of the content control function 26 or the SPI device 16 as a whole may be provided by the audio or video monitor 18. Those skilled in the art will recognize that the core functionality of the SPI device 16 as well as the content control function 26 is portable and may be provided in a device that is separate from the audio or video monitor 18, a device that resides in the audio or video monitor 18, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving a media content recommendation for a recommended media content item from a first party;
adding a select media content identifier for the recommended media content item to a playlist of a user, wherein the playlist comprises a plurality of media content identifiers corresponding to a plurality of media content items and consumption indicia adapted to control consumption of the plurality of media content items that are identified in the playlist; and
effecting execution of the playlist such that the plurality of media content items, including the recommended media content item, are consumed according to the consumption indicia at a scheduled programming interface (SPI) device of the user.

2. The method of claim 1 wherein the recommended media content item is a scheduled program that is scheduled to start at a defined time on a defined channel, and execution of the playlist will result in the SPI device selecting the defined channel by the defined time to enable consumption of the recommended media content item.

3. The method of claim 2 wherein at least two of the plurality of media content items are scheduled programs that are scheduled to start at different defined times on different defined channels, and execution of the playlist will result in the SPI device systematically selecting an appropriate one of the different defined channels by the different defined times to enable consumption of the at least two of the plurality of media content items.

4. The method of claim 2 wherein at least two of the plurality of media content items are scheduled programs that are available at the same time on different defined channels, and execution of the playlist enables consumption of the at least two of the plurality of media content items at the same time at the SPI device.

5. The method of claim 1 wherein the recommended media content item is an on demand program that is accessible upon request, and execution of the playlist will result in the recommended media content item being requested and the SPI device receiving the recommended media content for consumption.

6. The method of claim 1 wherein the recommended media content item is a program previously recorded by the user, and execution of the playlist will result in the recommended media content item being played back to the user via the SPI device.

7. The method of claim 6 wherein the program was locally recorded by the user on one of the SPI device and a device that is associated with the SPI device and located on premises of the user.

8. The method of claim 6 wherein the program was remotely recorded by the user on a network recording node that is remote from premises of the user.

9. The method of claim 1 wherein:
a first of the plurality of media content items is a scheduled program that is scheduled to start at a defined time on a defined channel, and execution of the playlist will result in the SPI device selecting the defined channel by the defined time to enable consumption of the scheduled program; and
a second of the plurality of media content items is an on demand program that is accessible upon request, and execution of the playlist will result in the recommended media content item being requested and the SPI device receiving the recommended media content for consumption.

10. The method of claim 1 wherein:
a first of the plurality of media content items is a scheduled program that is scheduled to start at a defined time on a defined channel, and execution of the playlist will result in the SPI device selecting the defined channel by the defined time to enable consumption of the scheduled program; and
a second of the plurality of media content items is program previously recorded by the user, and execution of the playlist will result in the program previously recorded by the user being played back to the user via the SPI device.

11. The method of claim 1 wherein the consumption indicia defines times at which at least certain of the plurality of media content items are to be consumed.

12. The method of claim 1 wherein the consumption indicia defines an order in which at least certain of the plurality of media content items are to be consumed when the playlist is executed.

13. The method of claim 1 wherein the consumption indicia defines times at which a first group of the plurality of media content items are to be consumed and an order in which a second group of the plurality of media content items are to be consumed when the playlist is executed.

14. The method of claim 1 wherein the playlist further comprises an advertising content identifier for an advertising content item, the consumption indicia is further adapted to control consumption of the advertising content item along with the plurality of media content items that are identified in the playlist, and execution of the playlist results in the advertising content item and the plurality of media content items being consumed according to the consumption indicia at the SPI device.

15. The method of claim 14 wherein the advertising content item is selected based on one of a group consisting of at least one of the plurality of media content items, at least one of the plurality of media content identifiers, information associated with at least one of the plurality of media content items, and information associated with at least one of the plurality of media content identifiers.

16. The method of claim 14 wherein the selected advertising content item is transferred to the SPI device prior to playlist consumption to facilitate timely insertion of the selected advertising content during media content consumption.

17. The method of claim 1 wherein each of the plurality of media content items is a television content item provided by a television service provider.

18. The method of claim 17 wherein the television service provider is one of a group consisting of a cable television service provider, a broadcast service provider, and a satellite service provider.

19. The method of claim 1 wherein effecting execution of the playlist comprises delivering the playlist to the SPI device, the SPI device adapted to automatically execute the playlist by controlling consumption of the plurality of media content items according to the consumption indicia.

20. The method of claim 1 wherein the recommended media item is consumed by presenting the media content item to the user.

21. The method of claim 1 wherein the recommended media item is consumed by recording the media content item.

22. The method of claim 1 wherein effecting execution of the playlist comprises delivering the playlist to a network control server, the network control server adapted to execute the playlist by controlling the SPI device such that the plurality of media content items are consumed according to the consumption indicia.

23. The method of claim 1 wherein effecting execution of the playlist comprises controlling the SPI device such that the plurality of media content items are consumed according to the consumption indicia.

24. The method of claim 1 wherein the SPI device resides in a customer premise of the user and is adapted to receive television service from one of a cable, satellite, or broadcast television service provider for the user.

25. The method of claim 1 wherein the SPI device is one of a group consisting of a set-top box, a digital video recorder, and a card providing a set-top box function.

26. The method of claim 1 wherein the recommended media content item is not available through a subscription of the user, and the consumption indicia further comprises authorization information that allows consumption of the recommended media content item at the SPI device.

27. An apparatus comprising:
at least one communication interface; and
a control system associated with the at least one communication interface and adapted to:
receive a media content recommendation for a recommended media content item from a first party;
add a select media content identifier for the recommended media content item to a playlist of a user, wherein the playlist comprises a plurality of media content identifiers corresponding to a plurality of media content items and consumption indicia adapted to control consumption of the plurality of media content items that are identified in the playlist; and
effect execution of the playlist such that the plurality of media content items, including the recommended media content item, are consumed according to the consumption indicia at a scheduled programming interface (SPI) device of the user.

28. The apparatus of claim 27 wherein the recommended media content item is a scheduled program that is scheduled to start at a defined time on a defined channel, and execution of the playlist will result in the SPI device selecting the defined channel by the defined time to enable consumption of the recommended media content item.

29. The apparatus of claim 28 wherein at least two of the plurality of media content items are scheduled programs that are scheduled to start at different defined times on different defined channels, and execution of the playlist will result in the SPI device systematically selecting an appropriate one of the different defined channels by the different defined times to enable consumption of the at least two of the plurality of media content items.
